(19) United States
(12) Patent Application Publication
(10) Pub. No.: US 2004/0224562 A1
(43) Pub. Date: Nov. 11, 2004

(54) Three-way connector

(76) Inventors: Thomas J. Dolinshek, New Baltimore, MI (US); Rene Curry, Gross Ile, MI (US); Mark Force, Sterling Heights, MI (US); Scott Wilton, Port Huron, MI (US)

Correspondence Address: BLANK ROME LLP, 600 NEW HAMPSHIRE AVENUE, N.W., WASHINGTON, DC, 20037, US

(21) Appl. No.: 10/777,221

(22) Filed: Feb. 13, 2004

Related U.S. Application Data
(60) Provisional application No. 60/447,313, filed on Feb. 14, 2003.

(51) Int. Cl. H01R 25/00

(52) U.S. Cl. 439/638

(57) ABSTRACT

A three-way electrical power and control connector for use in industrial environments, particularly, in assembly line and conveyor line type structures. The three-way connector is placed along various points in a main power or control line where a power or control device is located, to provide a drop line from the main line to the power or control device. The three-way connector includes three receptacles, two of which are used to connect portions of the main line. The third receptacle is used for the drop line which connects to the power or control device. The three-way connector allows the main line to be made up of several interconnected lines or cord sets, so that the power or control architecture can be easily customized to meet the user's needs, and can be easily modified if the user's needs change.

### FIELD OF INVENTION

The present invention is directed towards a three-way power and control connector used in an assembly line or conveyor line type environment. The three-way connector is placed in a main power or control line and allows for the quick attachment of a separate drop line to a power or control device. The “plug and play” capability of the connector allows for the quick installation of power and control devices and the subsequent modification of the wiring architecture.

### BACKGROUND OF THE INVENTION

Typically in industrial environments having an assembly line or conveyor line arrangement, a single power or control line is laid along the length of the assembly line with separate drop lines placed along various points to provide connections to various devices. These drop lines have traditionally been hard-wired using a “pipe and wire” structure, where the wiring is permanently fixed and any changes to the wiring required electricians to physically rewire the drop line. Due to the fixed nature of the wiring, its installation is expensive and cumbersome, and any changes to the wiring is expensive and time consuming.

Therefore, it would be desirable to provide a connector that allows power and control wiring to be quickly and easily installed. It would also be desirable to provide a three-way “plug and play” type connector for use in assembly line or conveyor type environments to be able to quickly add or remove drop lines to power and control devices as necessary.

### SUMMARY OF THE INVENTION

The present invention is directed to a three-way electrical power and control connector for use in industrial environments, particularly, in assembly line and conveyor line type structures. The three-way connector is placed along various points in a main line where a power or control device, such as a variable frequency drive, distributed controller or motor starter, is located and provides a drop line connecting these devices to the main line. The three-way connector includes three receptacles, two of which are used to connect portions of a main line and the third receptacle which is used as a drop line for connecting the power or control device. The three-way connector also allows the main line to be made up of several interconnected lines or cord sets, so that the power or control architecture can be easily customized to meet the user's needs, and can be easily modified if the user's needs change.

### BRIEF DESCRIPTION OF THE DRAWINGS

FIG. 1 shows a schematic diagram of a power or control line structure incorporating the three-way electrical connector of the present invention;

FIG. 2 shows a perspective view of the three-way power connector prior to attachment of power lines;

FIG. 3 shows a perspective view of the three-way power connector after attachment of power lines; and

FIG. 4 shows a perspective view of the three-way power connector of the present invention.

### DETAILED DESCRIPTION OF THE PREFERRED EMBODIMENTS OF THE INVENTION

Referring now to the several drawing figures in which identical elements are numbered identically throughout, a description of the preferred embodiments of the present invention will be provided.

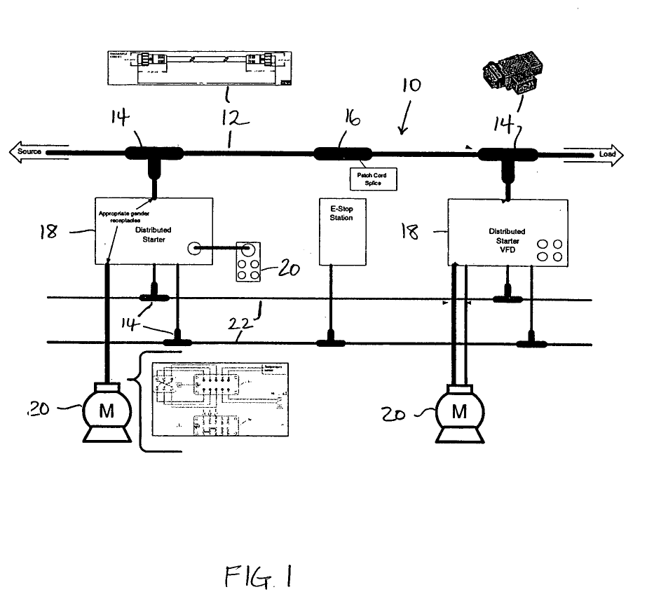

FIG. 1 shows a schematic drawing of the electrical wiring of an industrial environment having a conveyor or assembly line style architecture. The wiring comprises a main power or control line 10 made up of several individual cord sets 12. The cord sets 12 are connected by three-way connectors 14 of the present invention, which extend the main line, and provide a drop line to a power or control device 18. The three-way connectors 14 may be assembled in series to provide any number of drop lines from the main line 10. In addition to being connected by the three-way connector 14, the cord sets 12 may be connected by a patch cord splice 16 which simply connects two ends of the cord set 12 to extend the length of the main line 10.

The three-way connector 14 provides a quick and reliable connection of the main power and control line 10 to the power and control devices 18, such as variable frequency drives, distributed motor controllers and motor starters, as indicated generally by reference numeral 18. The connector 14 provides a “plug-and-play” environment that avoids system miss-wiring and allows the flexibility to easily adapt the wiring to meet future requirements. In a preferred embodiment, the connector 14 is designed to be used in industrial environments in conjunction with the DIN 43 652 (CECC 75 301-801) standard type of connector. This standard is the equivalent of European standard EN 175301-801:1999 relating to high density rectangular connectors with round removable crimp contacts. The standard provides for a variety of male and female connectors of variable sizes and varying number of contacts.

The power or control devices 18 are further connected to other devices 20 or power and control lines 22, as shown in the bottom portion of FIG. 1. The additional devices 20 and power and control lines 22 can similarly use the three-way connectors 14 to provide a variety of configurations and arrangements.

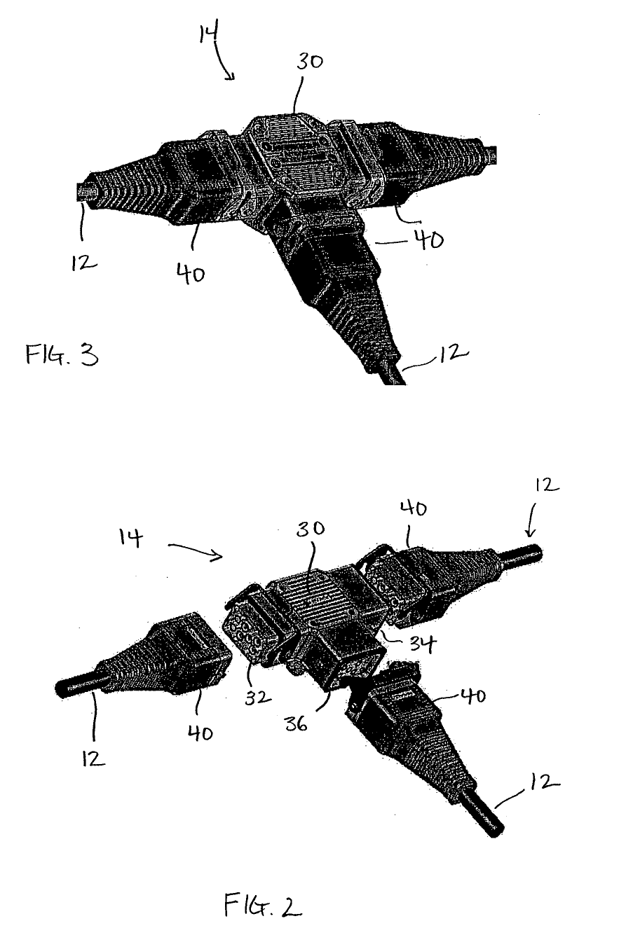

FIGS. 2 and 3 show perspective views of the three-way connector 14 prior to and after connection to cord sets 12, respectively. The connector 14 includes a central housing portion and three receptacle portions 32, 34, 36 placed around the housing portion 30. The two receptacles 32, 34 are placed on opposite sides of the housing 30 to connect separate cord sets 12 along the main line 10. The receptacle 32 is a female receptacle, while the receptacle 34 is a male receptacle. The third receptacle 36 is also a female receptacle, and is placed on a third side between the other two receptacles. FIG. 2 shows cord set ends 40 just prior to their attachment to the receptacles, and FIG. 3 shows the cord set ends 40 after attachment. The cord set ends 40 may be male or female, depending on the receptacle to which they are being attached. It should be understood that the invention contemplates any combination of male or female receptacles for the connector 14, for example, all three receptacles 32, 34, 36 may be female.

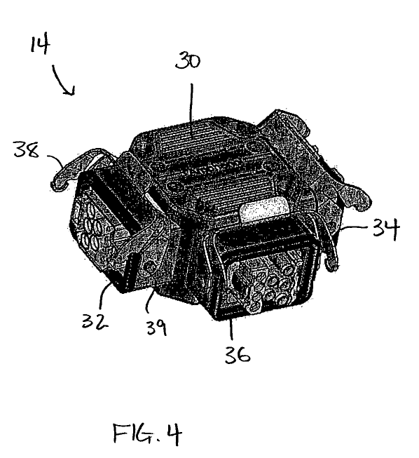

FIG. 4 shows a further view of the connector 14 having locking latches 38 on each receptacle 32, 34, 36. The latch 38 pivots about a pin 39 on the receptacle 32, 34, 36 to lock the ends of the cord sets 12 after attachment.

Although certain presently preferred embodiments of the present invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. A method of coupling electrical devices in an assembly-line type coupling structure of an industrial environment, comprising:
placing a three-way connector in a power or control main line that includes three receptacles for attaching to cord sets, two of the receptacles attaching main line cord sets thereby connecting individual main line cord sets to produce a single extended and reconfigurable main line, the third receptacle attaching to a drop line cord set, the drop line cord set connecting a device to the main line.

2. The method of claim 1, wherein:
the three-way connector conforms to the DIN 43 652 (CECC 75 301-801) standard.

3. The method of claim 1, wherein:
the receptacles include a locking latch for quick attachment and detachment of the cord sets.

4. A three-way connector for coupling electrical devices in an assembly-line type coupling structure of an industrial environment, comprising:
a three-way connector placed in a main line, the three-way connector including three receptacles for attaching to cord sets, two of the receptacles attaching main line cord sets, thereby connecting individual main line cord sets to produce a single extended and reconfigurable main line, the third receptacle attaching to a drop line cord set, the drop line cord set connecting a device to the main line.

5. The three-way connector of claim 1, wherein:
the three-way connector conforms to the DIN 43 652 (CECC 75 301-801) standard.

6. A three-way connector comprising:
a central housing portion and three receptacle portions, two of the three receptacle portions being located on opposite ends of the housing portion which are connected to a main power or control line, and the third receptacle portion connecting to a power or control device;
the connector conforming to the DIN 43 652 (CECC 75 301-801) standard.
